(19) United States
(12) Patent Application Publication
(10) Pub. No.: US 2020/0081281 A1
(43) Pub. Date: Mar. 12, 2020

(54) Array Substrate, Display Panel and Display Device

(71) Applicants: HKC Corporation Limited, Shenzhen (CN); Chongging HKC Optoelectronics Technology Co., Ltd., Chongging (CN)

(72) Inventor: Yu-Jen Chen, Chongqing (CN)

(21) Appl. No.: 16/615,641

(22) PCT Filed: Sep. 12, 2017
(86) PCT No.: PCT/CN2017/101369

§ 371 Date: Nov. 21, 2019

(30) Foreign Application Priority Data
Jun. 20, 2017 (CN) 201710471819.X

(51) Int. Cl. G02F 1/1362

(52) U.S. Cl. CPC G02F 1/1362; G02F 2001/136222; G02F 2201/52

(57) ABSTRACT

An array substrate, a display panel and a display device are provided. The array substrate includes a plurality of pixel regions disposed on a substrate. Each of the pixel regions includes a plurality of pixel units individually including a red pixel subunit, a green pixel subunit and a blue pixel subunit; and a plurality of blue photoresist film layers individually disposed on each of the blue pixel subunits. Wherein, the blue photoresist film layers of the two adjacent blue pixel subunits in each of the pixel regions have different thicknesses.

### CROSS-REFERENCE TO RELATED APPLICATION

The present application claims priority to China Patent Application No. 201710471819X, filed on Jun. 20, 2017, titled “ARRAY SUBSTRATE, DISPLAY PANEL AND DISPLAY DEVICE”, the entire contents of which are incorporated in the present application by reference.

### BACKGROUND

### 1. Field

The field of present application involves a display, in particular involves an array substrate, a display panel and a display device.

### 2. Description of the Related Art

The liquid crystal display (LCD) devices have been most widely used among the various flat panel display devices. With the development of the display technology, the LCD panels are becoming increasingly large in size.

At present, most of the large-sized display panels apply a negative vertical alignment (VA) type liquid crystal or in-plane switching (IPS) liquid crystal technology. The VA type liquid crystal technology has the advantages of higher production efficiency and lower manufacturing cost than the IPS liquid crystal technology, but has more significant defects in term of the optical properties thereof than the IPS liquid crystal technology. The large-size panels require the larger perspective presentation, particularly in the commercial applications, however, the drive circuit for driving the VA type liquid crystal display devices often cannot meet the market application requirement due to color shift at different view angles. For example, as the voltage increases, the brightness saturation tendency of the blue pixel subunit is more significant and faster than that of the red and green pixel subunits such that the bluish image quality defect is significantly presented at side view angles.

Generally, the method of solving color shift of the VA Type liquid crystal technology is to further subdivide each of RGB sub-pixels into main pixels/sub-pixels and apply the different driving voltages to the main pixels and the sub-pixels so as to improve the color shift defect at different view angles, but it is often necessary to design the additional metal trace or thin film transistor (TFT) components for driving the sub-pixels in such configuration of the pixel, so it only needs to sacrifice the transparent opening area result in affecting the transmittance of the panel, but also increases the backlight cost.

### SUMMARY

The various embodiments of the present application provide an array substrate, a display panel and a display device.

The array substrate includes a plurality of pixel regions are disposed on a substrate; wherein each of the pixel regions includes a plurality of pixel units; each of the pixel units includes a red pixel subunit, a green pixel subunit and a blue pixel subunit; and a plurality of blue photoresist film layers individually disposed on each of the blue pixel subunits; wherein the blue photoresist film layers of the two adjacent blue pixel subunits in each of the pixel regions have different thicknesses.

In an embodiment, each of the pixel regions includes a plurality of pixel units arranged in an array.

In an embodiment, the pixel unit in each pixel area has the same number of columns as rows; and the thickness of the blue photoresist film layer at column i and row j is as same as the thickness of the blue photoresist film layer at column j and row i; wherein i and j are all smaller than or equal to the number of columns.

In an embodiment, each of the pixel regions includes four pixel units arranged in two columns and two rows; wherein the blue photoresist film layers of the blue pixel subunits in the two pixel units that are arranged diagonally have same thickness.

In an embodiment, each of the pixel regions includes four pixel units arranged in two columns and two rows; wherein the blue photoresist film layers of the blue pixel subunits of the four pixel units in the same pixel region have different thicknesses.

In an embodiment, each of the pixel regions includes nine pixel units arranged in 3×3 matrix; wherein the matrix of the film thicknesses of the blue photoresist film layers in each of the blue pixel subunits corresponding to the nine pixel units arranged in 3×3 matrix is:

$$( \begin{matrix}B - CF 33 & B - CF 32 & B - CF 31 \\ B - CF 32 & B - CF 33 & B - CF 32 \\ B - CF 31 & B - CF 32 & B - CF 33\end{matrix} )$$

In an embodiment, each of the pixel regions includes nine pixel units arranged in 3×3 matrix; wherein the blue photoresist film layers of each of the blue pixel subunits in the nine pixel units have different thicknesses.

In an embodiment, each of the pixel regions includes sixteen pixel units arranged in 4×4 matrix; wherein the matrix of the film thicknesses of the blue photoresist film layers in each of the blue pixel subunits corresponding to the sixteen pixel units arranged in 4×4 matrix is:

$$( \begin{matrix}B - CF 44 & B - CF 43 & B - CF 42 & B - CF 41 \\ B - CF 43 & B - CF 42 & B - CF 43 & B - CF 42 \\ B - CF 42 & B - CF 43 & B - CF 42 & B - CF 43 \\ B - CF 41 & B - CF 42 & B - CF 43 & B - CF 44\end{matrix} )$$

In an embodiment, each of the pixel regions includes sixteen pixel units arranged in 4×4 matrix; wherein the blue photoresist film layers of each of the blue pixel subunits in the sixteen pixel units have different thicknesses.

In an embodiment, the green pixel subunit is located in the middle of the red pixel subunit and the blue pixel subunit in each of the pixel units.

The display panel includes a first substrate and a second substrate, the first substrate and the second substrate are disposed to oppose each other; the first substrate is any of the above array substrates. For example, the first substrate includes a plurality of pixel regions are disposed on a substrate, wherein each of the pixel regions includes a plurality of pixel units including a red pixel subunit, a green pixel subunit and a blue pixel subunit; a plurality of blue photoresist film layers individually disposed on each of the blue pixel subunits; wherein the blue photoresist film layers of the two adjacent blue pixel subunits in each of the pixel regions have different thicknesses.

The display device includes a data receiving chip, a display panel and a driver board, the display panel includes any of the above array substrates, the driver board includes a timing control circuitry; wherein, the data receiving chip and the display panel are connected to each other; the timing control circuit and the data receiving chip are connected to each other, the timing control circuit is configured to process an initial drive voltage signal for each of the pixel subunits, such that the processed driving voltages of the plurality of blue pixel subunits at the same column/row in the same pixel region are same, and configured to output the processed driving voltage signal to the data receiving chip.

In an embodiment, the timing control circuit is configured to process the initial drive voltage signal of each of the pixel subunits, such that the processed driving voltage of each of the plurality of blue pixel subunits is equal to a mean value of the initial driving voltages of the plurality of blue pixel subunits at the same row/column in the same pixel region, and the timing control circuit is configured to output the processed driving voltage signal to the data receiving chip.

In an embodiment, the timing control circuit is further configured to output the processed driving voltage signal to the data receiving chip at a displaying time of the next frame after processing the initial drive voltage signal for each of the pixel subunits.

In an embodiment, the timing control circuit includes a signal processing unit configured to process the initial drive voltage signal for each of the pixel subunits, such that the processed driving voltages of the plurality of blue pixel subunits at the same column/row in the same pixel region are same; and a storage unit configured to receive and store the processed driving voltage signal, and output the processed driving voltage signal at a displaying time of the next frame.

According to the present application, the structures of the blue pixel subunits are adjusted for the optical characteristic of the blue pixel subunits, when the blue photoresist film layers in the same pixel region are adjusted to have different thicknesses, the short wavelength and high color shift conditions are compensated so as to realize a complementary optical effect, thereby solving the chromatic aberration and color shift problems of the display panel. The aforementioned processes for the array substrate are simple and can improve the display performance of the display device.

It is not necessary to further subdivide the same pixel subunit and apply the different driving voltages to the subdivided pixel subunits respectively by the adjustment of the blue pixel subunits in each of the pixel regions for the optical characteristics. Therefore, it is not need to design the additional metal or TFT components for driving the sub-pixels so as to save the backlight cost, and not need to sacrifice the transparent opening area so as to maintain the excellent transmittance of the panel.

### BRIEF DESCRIPTION OF THE DRAWINGS

In order to more clearly describe the technical solutions of the embodiments of the present application or of the conventional art, the accompanying drawings for the description of the embodiments or the conventional art will be briefly introduced below. It is apparent that the accompanying drawings in the following description are only some embodiments of the present application, one skilled in the art can obtain other drawings of other embodiments according to those accompanying drawings without any creative work.

FIG. 1 is a schematic structural diagram of an array substrate of an embodiment.

FIG. 2 is a schematic diagram of a variation curve of a brightness of a blue pixel subunit versus a voltage of an embodiment.

FIG. 3 is a schematic structural diagram of an array substrate of another embodiment.

FIG. 4 is a schematic structural diagram of an array substrate of yet another embodiment.

FIG. 5a is a schematic structural diagram of an array substrate of yet another embodiment.

FIG. 5b is a schematic structural diagram of an array substrate of yet another embodiment.

FIG. 6a is a schematic structural diagram of a display panel of an embodiment.

FIG. 6b is a schematic structural diagram of a display panel of another embodiment.

FIG. 7 is a schematic structural diagram of a display device of an embodiment.

### DETAILED DESCRIPTION OF THE PREFERRED EMBODIMENTS

For a better understanding of the present application, the more comprehensive descriptions of the present application will be provided with reference to the related accompanying drawings as follows. The accompanying drawings illustrate the preferred embodiments of the present application. However, the present application may be implemented in many different forms and is not limited to the embodiments described herein. Inversely, those embodiments are provided to more thoroughly and comprehensively understand the disclosure of the present application.

Unless defined otherwise, all technical and scientific terms used herein have the same meaning as commonly understood by one skilled in the art to which the present application belongs. The terminology used herein is for the purpose of describing specific embodiments only and is not intended to limit the present application. As used herein, the term “and/or” includes any and all combinations of one or more of the associated listed items.

For example, an array substrate includes a plurality of pixel regions are disposed on a substrate, wherein each of the pixel regions includes a plurality of pixel units individually including a red pixel subunit, a green pixel subunit and a blue pixel subunit; and a plurality of blue photoresist film layers individually disposed on each of the blue pixel subunits; wherein the blue photoresist film layers of the two adjacent blue pixel subunits in each of the pixel regions have different thicknesses.

For example, a display panel includes a first substrate and a second substrate, the first substrate and the second substrate are disposed to oppose each other, and the first substrate is the above array substrate. For example, the first substrate includes a substrate and a plurality of pixel regions on the substrate, each of the pixel regions includes a plurality of pixel units individually including a red pixel subunit, a green pixel subunit and a blue pixel subunit; and a plurality of blue photoresist film layers individually disposed on each of the blue pixel subunits; wherein the blue photoresist film layers of the two adjacent blue pixel subunits in each of the pixel regions have different thicknesses; optionally, a TFT array is also formed on the first substrate; alternatively, a TFT array is formed on the second substrate.

For example, a display device includes a data receiving chip, a display panel and a driver board, wherein the display panel includes the above array substrate, the data receiving chip and the display panel are connected to each other; the driver board includes a timing control circuit connected to the data receiving chip, the timing control circuit is configured to process an initial drive voltage signal for each of the pixel subunits such that the processed driving voltages of the plurality of blue pixel subunits at the same column/row in the same pixel region are same, and configured to output the processed driving voltage signal to the data receiving chip.

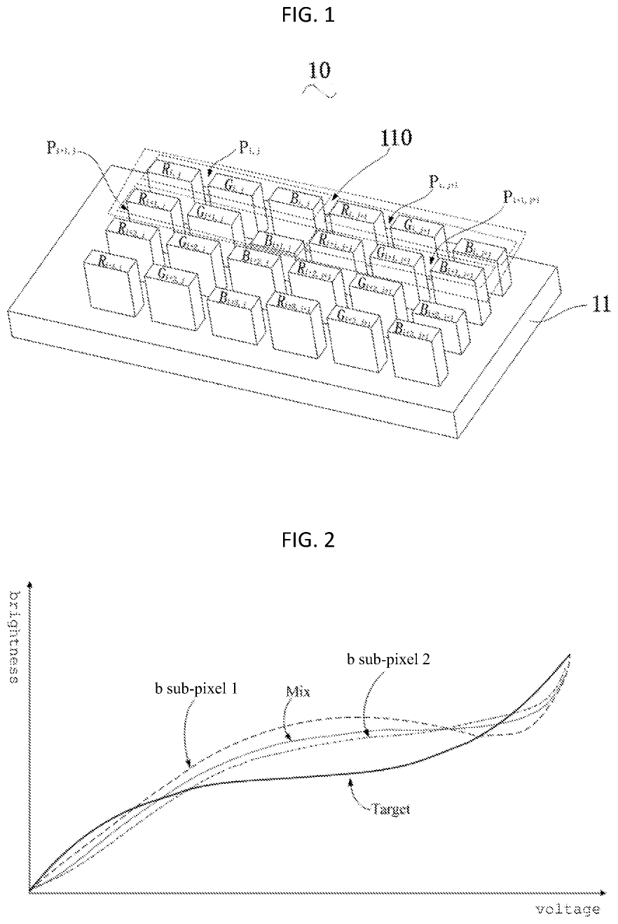

For the sake of better understanding, the above array substrate, display panel and display device are described with reference to the accompanying drawings as follows. Please refer to FIG. 1, which is a schematic structural diagram of an array substrate of an embodiment. The array substrate 10 includes a substrate 11 on which a plurality of pixel regions 110 are disposed, each of the pixel regions 110 includes a plurality of pixel units P each including a red pixel subunit, a green pixel subunit and a blue pixel subunit, a photoresist film layer is disposed on each of the pixel subunits, for example, a red photoresist film layer R is disposed on the red pixel subunit, a green photoresist film layer G is disposed on the green pixel subunit, a blue photoresist film layer B is disposed on the blue pixel subunit.

Specifically, the blue photoresist film layers of the two adjacent pixel subunits in each of the pixel region have different thicknesses. For example, as shown in FIG. 1, the thickness of the blue photoresist film layer B_{i+1, j} and the thickness of the blue photoresist film layer B_{i, j+1} are different from the thickness of the blue photoresist film layer B_{i, j} respectively; the thickness of the blue photoresist film layer B_{i, j+1} and the thickness of the blue photoresist film layer B_{+1, j} are different from the thickness of the blue photoresist film layer B_{i+1, j+1} respectively; wherein, P_{i, j} represents the pixel unit at column i and row j, B_{i, j} represents the photoresist film layer in the pixel unit at column i and row j.

In the embodiment, since the blue photoresist film layers of the two adjacent pixel subunits in the same pixel region have different film thicknesses, the different gap distances between the blue photoresist film layers and the TFT substrates, wherein the gap distance between the blue photoresist film layer and the TFT substrate is also called a gap value. The optical characteristic parameter of each of the pixel subunits is related to the gap value, for example, an amount of phase delay of each of the pixel subunits is related to the gap value, the amount of phase delay may affect change of polarization state of light so as to affect the brightness of light emitted from the pixel subunit. That is, the brightness of each of pixel subunits is related to the gap value and there are different curve relationships between the brightness and the gap value of the different pixel subunits at the same voltage.

In the embodiment, the plurality of blue pixel subunits have different gap values in the same pixel region, such that the curve of the optical characteristics of the blue pixel subunits in the same pixel region versus the voltage is equivalent to the mean value of the curve corresponding to the different gap values at side view angles, so as to brightness variation of the blue pixel subunit may be controlled for the mixed light at side view angles such that the complementary brightness saturation tendency of the blue pixel subunit in the same pixel region at side view angles is controlled to approximate to that of the red pixel subunit and the green pixel subunit. The brightness ratio of each of the red, green and blue pixel subunits may be maintained as the original ratio of the conventional technology by the complementary adjustment of the adjacent pixel units at a front view angle. That is, according to the embodiments of the present application, each of the red, green and blue pixel subunits in the same pixel region exhibit the approximate saturation tendency at a front view angle and side view angles so as to improve the color shift condition at side view angles. Since the size of the pixel unit is very small, the size of the pixel region including the plurality of pixel units is small, and thus it is difficult to distinguish the brightness difference of the single pixel in the pixel region, but the overall brightness of each of the display areas is sensed, when viewed by the human eye. Therefore, the embodiments of the present application can ensure the uniformity of the overall display brightness while improving the color shift condition at side view angles.

It should be noted that in the embodiments of the present application, the blue photoresist films of the adjacent blue pixel subunits in the same pixel region have different thicknesses, and the plurality of blue pixel subunits in the same pixel region are together used to compensate chromatic aberration at the different view angles, so it needs to sacrifice the resolution of the blue pixel subunit when performing signal adjustment. For example, the plurality of blue pixel subunits at the same column/row in the same pixel region are applied with the same voltage signal during the displaying time period of the same frame to realize an effect of compensating chromatic aberration at different view angles by using the photoresist films having different thicknesses.

It is not necessary to further subdivide the same pixel subunit and apply the different driving voltages to the subdivided pixel subunits respectively by the adjustment of the blue pixel subunits in each of the pixel regions for the optical characteristics. Therefore, it is not need to design the additional metal or TFT components for driving the sub-pixels so as to save the backlight cost, and not need to sacrifice the transparent opening area so as to maintain the excellent transmittance of the panel.

In an embodiment, each of the pixel regions includes a plurality of pixel units arranged in an array. Wherein, the number of columns of the pixel unit is different from the number of rows of the pixel unit in each of the pixel regions. Preferably, the number of columns is as same as the number of rows for the pixel region in each of the pixel regions that is the number of columns of the pixel unit is as same as the number of rows of the pixel unit, and the thickness of the blue photoresist film layer at column i and row j is same as that at the column j and row i, wherein i and j are all smaller than or equal to the number of columns.

In an embodiment, each of the pixel regions include four pixel units arranged in two columns and two rows that is the four pixel units are arranged in 2×2 matrix. As shown in FIG. 1, the one pixel region includes four unit units which are represented by P_{i, j}, P_{i, j+1}, P_{i+1, j} and P_{i+1, j+1} respectively, the blue photoresist film layers of the corresponding four blue pixel subunits thereof are represented by B_{i, j}, B_{i, j+1}, B_{i+1, j} and B_{i+1, j+1} respectively.

As an embodiment, the blue photoresist film layers of the blue pixel subunits in the two pixel units that are disposed diagonally include have the same thickness that is the blue photoresist film layer B_{i, j} and the blue photoresist film layer B_{i+1, j+1} have the same thickness that is represented by B-CF21; the blue photoresist film layer B_{i, j+1} and the blue photoresist film layer B_{i+1, j} have the same thickness that is represented by B-CF22. Wherein, the gap value corresponding to the thickness B-CF21 is represented by B-Gap21, the gap value corresponding to the thickness B-CF22 is represented by B-Gap22. There are two different gap values in the same pixel region and the amount of phase delay of the entire pixel region is equal to about mean value of the amount of the phase delay corresponding to the two gap values such that the optical parameters of the entire pixel region are adjusted to realize a complementary optical effect, and thus the complementary brightness saturation tendency of the blue pixel subunit in the same pixel region approximates to that of the red pixel subunit and the green pixel subunit at side view angles, thereby improving the color shift condition at side view angles.

At this time, the plurality of blue pixel subunits at the same column/row in the pixel region are applied with the same voltage signal during the displaying time period of the same frame to realize an effect of compensating chromatic aberration at different view angles with the photoresist films having different thicknesses. For example, the timing control circuitry processes the initial driving voltages of each of the pixel subunits to convert the driving voltages of the plurality of blue pixel subunits at the same column/row in the pixel region into the mean value of the initial driving voltages of the blue pixel subunits at the column/row, and timing control circuitry outputs the processed driving voltage signal at the displaying time in the next frame or the subsequent frame thereof. Further, for example, the timing control circuitry receives the initial driving voltage signal for each of the pixel subunits at the displaying time of the Nth frame, wherein the initial driving voltages of the blue pixel subunits of the pixel P_{i, j}, the pixel P_{i, j+1}, the pixel P_{i+1, j} and the pixel P_{i+1, j+1} are represented by BN_{i, j}, BN_{i, j+1}, BN_{i+1, j} and BN_{i+1,j+1} respectively, the timing control circuitry processes the initial driving voltages BN_{i, j}, BN_{i, j+1}, BN_{i+1, j} and BN_{i+1, j+1}. As a processing manner, the actual driving voltage applied to the blue pixel subunits of the pixel P_{i, j} and the pixel P_{i,j+1} is a mean value of BN_{i, j} and BN_{i, j+1}, the actual driving voltage applied to the blue pixel subunits of the pixel P_{i+1, j} and the pixel P_{i+1, j+1} is a mean value of BN_{i+1, j} and BN_{i+1, j+1}. As another processing manner, the actual driving voltage applied to the blue pixel subunits of the pixel P_{i, j} and the pixel P_{i+1, j} is a mean value of BN_{i, j} and BN_{i+1, j}, the actual driving voltage applied to the blue pixel subunits of the pixel P_{i, j+1} and the pixel P_{i+1, j+1} is a mean value of B_{Ni, j+1} and BN_{i+1, j+1}. The processed driving voltage signal (which is an actual driving voltage signal applied to each of the pixel subunits) is outputted to the display panel after delaying a time of at least one frame. Preferably, the timing control circuitry receives the initial driving voltage signal of each of the pixel subunits at the displaying time of the Nth frame, and outputs the processed driving voltage signal to each of the pixel units of the display panel at a displaying time of the N+1 frame, so the image information is transmitted to the display panel after delaying the time of one frame and the image is displayed after delaying the time of one frame.

At this time, as shown in FIG. 2, Target curve is a target variation curve of the brightness of the blue pixel subunit versus the voltage, b sub-pixel 2 curve is a target variation curve of the brightness of the blue pixel subunit versus the voltage corresponding to B-CF21, b sub-pixel 1 curve is a target variation curve of the brightness of the blue pixel subunit versus the voltage corresponding to B-CF22, wherein B-CF21>B-CF22. The Mix curve is a variation curve of the overall brightness of light emitted from the blue pixel subunits in the display area of the above array substrate versus the voltage, the thicknesses of the blue photoresist film layers of any two adjacent blue pixel subunits in the array substrate are represented by B-CF21 and B-CF22 respectively. FIG. 2 shows that the Mix curve is more approximate to the target variation curve with respect to the b sub-pixel 1 curve and b sub-pixel 2 curve, and therefore, the brightness of light emitted from the above array substrate including the blue pixel subunits any adjacent two of which includes the blue photoresist film layers having different thicknesses is more satisfied with the color shift requirement at side view angles.

As another embodiment, the blue photoresist film layers of the blue pixel subunits of the four pixel units have different thicknesses in the same pixel region, it means that the four blue photoresist film layers having four different thicknesses in the same pixel region. For example, as shown in FIG. 1, the blue photoresist film layers B_{i, j}, B_{i, j+1}, B_{i+1, j} and B_{i+1, j+1} of the four blue pixel subunits of the pixel P_{i, j}, the pixel P_{i, j+1}, the pixel P_{i+1, j} and the pixel P_{i+1, j+1} have different thicknesses. At this time, the timing control circuit is configured to process the initial drive voltage signal for each of the pixel subunits to convert the driving voltages of each of the blue pixel subunits in the pixel region into the mean value of the initial driving voltages of the four blue pixel subunits, and the timing control circuit is configured to output the processed driving voltage signal at the displaying time in the next frame or the subsequent frame thereof.

In an embodiment, the variation curve of the overall brightness of the blue pixel subunit in each of the pixel regions versus a voltage at side view angles is more approximate to the target variation curve by using the photoresist film layers having more different thicknesses in each of the pixel regions. As such, there are more different gap values between the photoresist film layer of the blue pixel subunit and the TFT substrate in the same pixel region, the optical characteristic curve of the blue pixel subunit can be adjusted more finely such that the displaying effect of the display panel is better.

As an embodiment, each of the pixel regions includes nine pixel units arranged in three columns and three rows that is the four pixel units are arranged in 3×3 matrix. For example, the nine pixel units in the pixel region are arranged in the following matrix:

$$( \begin{matrix}{P}_{i , j} & {P}_{i , j + 1} & {P}_{i , j + 2} \\ {P}_{i + 1 , j} & {P}_{i + 1 , j + 1} & {P}_{i + 1 , j + 2} \\ {P}_{i + 2 , j} & {P}_{i + 2 , j + 1} & {P}_{i + 2 , j + 2}\end{matrix} )$$

In an embodiment, the matrix of the film thicknesses of the blue photoresist film layers in each of the blue pixel subunits corresponding to the pixel matrix arranged in three columns and three rows is:

$$( \begin{matrix}B - CF 33 & B - CF 32 & B - CF 31 \\ B - CF 32 & B - CF 33 & B - CF 32 \\ B - CF 31 & B - CF 32 & B - CF 33\end{matrix} )$$

That is, the blue photoresist film layers of the blue pixel subunits of the pixel P_{i, j}, the pixel P_{i+1, j+1} and the pixel P_{i+2, j+2} have the same thickness, the blue photoresist film layers of the blue pixel subunits of the pixel P_{i, j+1}, the pixel P_{i+1, j}, the pixel P_{i+1, j+2} and the pixel P_{i+2, j+1} have the same thickness, the blue photoresist film layers of the blue pixel subunits of the pixel P_{i, j+2} and the pixel P_{i+2, j} have the same thickness. In a preferable embodiment, B-CF33>B-CF32>B-CF31. At this time, the three different gap values are between the photoresist film layer of the blue pixel subunits and the TFT substrate in the same pixel region and represented as B-Gap31, B-Gap32 and B-Gap33 from small to large respectively, the amounts of the phase delay respectively corresponding thereto are represented as Δ nd_{B-Gap31}, Δ nd_{B-Gap32}, Δ nd_{B-Gap33} and Δ nd_{B-Gap34} respectively, since there is a difference between B-Gap31, B-Gap32 and B-Gap33, the actual amount of the phase delay of the blue pixel subunit in the same pixel region is equal to about a mean value of Δnd_{B-Gap31}, Δnd_{B-Gap32} and Δnd_{B-Gap33}, and thus it can realize a complementary optical effect to compensate an affect caused by chromatic aberration at different view angles, thereby improving color shift at side view angles.

In order to realize a better color shift effect, as an embodiment, the timing control circuitry processes the initial driving voltage signal for each of the pixel subunits such that the processed driving voltage of the pixel P_{i, j}, the pixel P_{i, j+1} and the pixel P_{i, j+2} is a mean value of the initial driving voltage thereof; the driving voltages of the pixel P_{i+1, j}, the pixel P_{i+1, j+1} and the pixel P_{i+1, j+2} are a mean value of the initial driving voltage thereof; the driving voltages of the pixel P_{i+2, j}, the pixel P_{i+2, j+1} and the pixel P_{i+2, j+2} are a mean value of the initial driving voltage thereof. As another example, the timing control circuitry processes the initial driving voltage signal for each of pixel subunits such that the processed driving voltages of the pixel P_{i, j}, the pixel P_{i+1, j} and the pixel P_{i+2, j} are a mean value of the initial driving voltages thereof; the driving voltages of the pixel P_{i, j+1}, the pixel P_{i+1, j+1} and the pixel P_{i+2, j+1} are a mean value of the initial driving voltage thereof; the driving voltages of the pixel P_{i, j+2}, the pixel P_{i+1, j+2} and the pixel P_{i+2, j+2} are a mean value of the initial driving voltage thereof.

In another embodiment, the blue photoresist film layers of the blue pixel subunits of the nine pixel units in the same pixel region have different thicknesses, it means that the blue photoresist film layers have nine different film thicknesses in the same pixel area. At this time, the timing control circuitry may process the initial driving voltage for each of the pixel subunits to convert the driving voltage of each of the blue pixel subunits into the mean value of the initial driving voltages of the nine blue pixel subunits, and output the processed driving voltage signal at the displaying time in the next frame or the subsequent frame thereof.

As an embodiment, each of the pixel regions includes sixteen pixel units which are arranged in four columns and four rows that is the four pixel units are arranged in a 4×4 matrix; for example, the sixteen pixel units in the pixel region are arranged in the following matrix:

$$( \begin{matrix}{P}_{i , j} & {P}_{i , j + 1} & {P}_{i , j + 2} & {P}_{i , j + 3} \\ {P}_{i + 1 , j} & {P}_{i + 1 , j + 1} & {P}_{i + 1 , j + 2} & {P}_{i + 1 , j + 3} \\ {P}_{i + 2 , j} & {P}_{i + 2 , j + 1} & {P}_{i + 2 , j + 2} & {P}_{i + 2 , j + 3} \\ {P}_{i + 3 , j} & {P}_{i + 3 , j + 1} & {P}_{i + 3 , j + 2} & {P}_{i + 3 , j + 3}\end{matrix} )$$

In an embodiment, the matrix of the film thicknesses of the blue photoresist film layers in each of the blue pixel subunits corresponding to the pixel matrix arranged in four columns and four rows is:

$$( \begin{matrix}B - CF 44 & B - CF 43 & B - CF 42 & B - CF 41 \\ B - CF 43 & B - CF 42 & B - CF 43 & B - CF 42 \\ B - CF 42 & B - CF 43 & B - CF 42 & B - CF 43 \\ B - CF 41 & B - CF 42 & B - CF 43 & B - CF 44\end{matrix} )$$

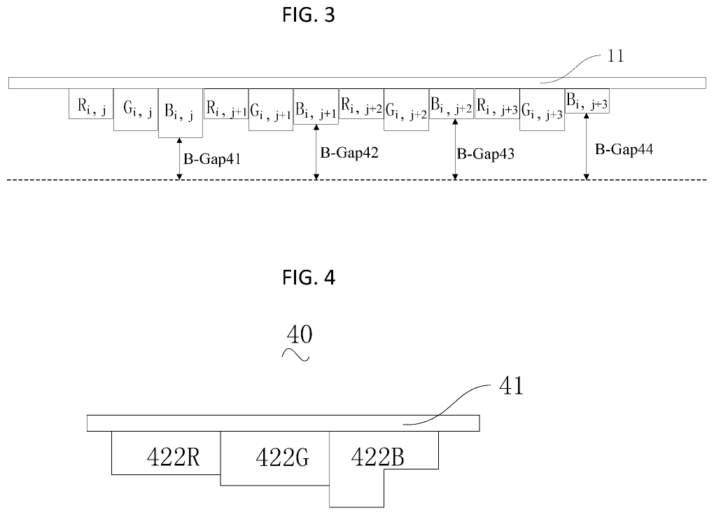

That is, the blue photoresist film layers of the blue pixel subunits of the pixel P_{i, j} and the pixel P_{i+3, j+3} have the same thickness, the blue photoresist film layers of the blue pixel subunits of the pixel P_{i, j+1}, the pixel P_{i+1, j}, the pixel P_{i+1, j+2}, the pixel P_{i+2, j+1}, the pixel P_{i+2, j+3} and the pixel P_{i+3, j+2} have the same thickness, the blue photoresist film layers of the blue pixel subunits of the pixel P_{i, j+2}, the pixel P_{i+1, j+1}, the pixel P_{i+1, j+3}, the pixel P_{i+2, j}, the pixel P_{i+2, j+2} and the pixel P_{i+3, j+1} have the same thickness, the blue photoresist film layers of the blue pixel subunits of the pixel P_{i, j+3} and the pixel P_{i+3, j} have the same thickness. In a preferred embodiment, B-CF44>B-CF43>B-CF42>B-CF41. As shown in FIG. 3, the four gap values are between the photoresist film layer and the TFT substrate of the blue pixel subunit in each of the pixel regions at this time and represented by B-Gap41, B-Gap42, B-Gap43 and B-Gap44 respectively from small to large and the corresponding amounts of phase delay are represented by Δnd_{B-Gap41}, Δnd_{B-Gap42}, ΔndB_{-Gap43} and Δnd_{B-Gap44} thereof respectively. The amounts of phase delay of the blue pixel subunit are actually equal to about mean value of Δnd_{B-Gap41}, A nd_{B-Gap42}, Δ nd_{B-Gap43} and Δ nd_{B-Gap44} since the difference between B-Gap41, B-Gap42, B-Gap43 and B-Gap44, such that it can realize the complementary optical effect to compensate an affect caused by chromatic aberration at different view angles, thereby improving color shift at side view angles.

In order to realize a better color shift effect, as an embodiment, the timing control circuitry processes the initial driving voltage signal for each of the pixel subunits such that the processed driving voltages of the pixel P_{i, j}, the pixel P_{i, j+1}, the pixel P_{i, j+2} and the pixel P_{i, j+3} are equal to the mean value of the initial driving voltage thereof; the driving voltages of the pixel P_{i+1, j}, the pixel P_{i+1, j+1}, the pixel P_{i+1, j+2} and the pixel P_{i+1, j+3} are equal to the mean value of the initial driving voltages thereof; the driving voltages of the pixel P_{i+2, j}, the pixel P_{i+2, j+1}, the pixel P_{i+2, j+2} and the pixel P_{i+2, j+3} are equal to the mean value of the initial driving voltages thereof; the driving voltages of the pixel P_{i+3,j}, the pixel P_{i+3, j+1} and the pixel P_{i+3, j+2} the pixel P_{i+3, j+3} are equal to the mean value of the initial driving voltages thereof. As another embodiment, the timing control circuitry processes the initial driving voltage signal for each of the pixel subunits such that the processed driving voltages of the pixel P_{i, j}, the pixel P_{i+1, j}, the pixel P_{i+2, j} and the pixel P_{i+3, j} are equal to the mean value of the initial driving voltages thereof; the driving voltages of the pixel P_{i, j+1}, the pixel P_{i+1, j+1}, the pixel P_{i+2, j+1} and the pixel P_{i+3, j+1} are equal to the mean value of the initial driving voltages thereof; the driving voltages of the pixel P_{i, j+2}, the pixel P_{i+1, j+2}, the pixel P_{i+2, j+2} and the pixel P_{i+3, j+2} are equal to the mean value of the initial driving voltages thereof; the driving voltages of the pixel P_{i,j+3}, the pixel P_{i+1,j+3}, the pixel P_{i+2, j+3} and the pixel P_{i+3, j+3} are equal to the mean value of the initial driving voltages thereof.

In another embodiment, the blue photoresist film layers of the sixteen pixel units in the same pixel region have different thicknesses, it means that the blue photoresist film layers have sixteen different film thicknesses in the same pixel area. At this time, the timing control circuitry may process the initial driving voltage for each of the pixel subunits to convert the driving voltage of each of the blue pixel subunits into the mean value of the initial driving voltages of the sixteen blue pixel subunits, and output the processed driving voltage signal at the displaying time in the next frame or the subsequent frame thereof.

In an embodiment, the green pixel subunit is located in the middle of the red pixel subunit and the blue pixel subunit in each of the pixel units. As such, it is advantageous that the three primary colors of red, green and blue are mixed to obtain various colors.

In an embodiment, the array substrate further includes a light-blocking layer formed on the substrate and having an opening, the photoresist film layer is disposed at the opening of the light-blocking layer. In some embodiments, the light-blocking layer may be a black matrix, wherein the light-blocking layer having the opening may be considered as a black frame for enclosing each of the pixel subunits. The substrate is subdivided into a plurality of pixel units and each of the pixel units are subdivided into three pixel subunits such as red, green and blue pixel subunits by the light-blocking layer having the opening. The opening of the light-blocking layer is filled with the photoresist film layer having the corresponding color to prepare an array substrate, wherein the light-blocking layer not only prevents the background light from leaking to improve display contrast, but also prevents the colors from mixing to increase the color purity. Optionally, the light-blocking layer is made of a metal material such as Cr or a black resin material, for example, the thickness of the light-blocking layer is larger than the thickness of the photoresist film layer. For example, the light-blocking layer includes a plurality of black unit bodies arranged in a regular matrix, each of the black unit bodies has an opening; the adjacent two black unit bodies are connected to each other and arranged tightly. Alternatively, the light-blocking layer is a black frame through which a plurality of openings are disposed, each of the openings are arranged in a matrix. The black frame is made of a metal material such as Cr or a black resin material.

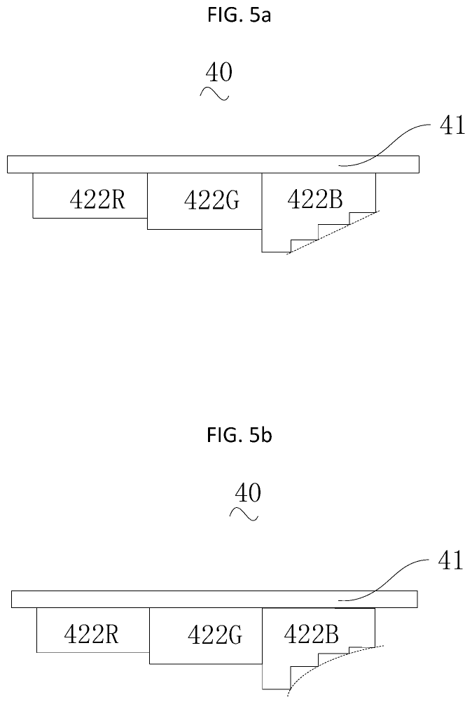

Please refer to FIG. 4, which is a schematic structural diagram of an array substrate of a yet another embodiment. The array substrate 40 includes a substrate 41 on which a plurality of pixel units are disposed, each of the pixel units includes a first pixel subunit, a second pixel subunit and a third pixel subunit, wherein the photoresist film layer 42 is disposed on each of the pixel subunits of the substrate 41, and the photoresist film layers made of different materials are disposed in the different pixel subunits in the same pixel unit respectively such that the different pixel subunits in the same pixel unit emit light having different colors. For example, the first pixel subunit is a red pixel subunit, the second pixel subunit is a green pixel subunit, the third pixel subunit is a blue pixel subunit, a red photoresist film layer 422R is disposed in the first pixel subunit, a green photoresist film layer 422G is disposed in the second pixel subunit, a blue photoresist film layer 422B is disposed in the third pixel subunit. Wherein, the photoresist film layer is located between the substrate 41 and the second substrate, and the photoresist film layer 422B of the third pixel subunit has a step structure that is the blue photoresist film layer 422B has the step structure.

In the embodiment, the photoresist film layers in the third pixel subunit have different film thicknesses by the step structure, and thus the different gap distances are between the blue photoresist film layer and the second substrate, wherein the gap distance between the photoresist film layer and the second substrate is also called a gap value. The optical characteristic parameter of each of the pixel subunits is related to the gap value, for example, the amount of phase delay of each of the pixel subunits is related to the gap value, and the amount of phase delay may affect change of polarization state of light so as to affect the brightness of light emitted from the pixel subunit. That is, the brightness of each of pixel subunits is related to the gap value and there are different curve relationships between the brightness and the gap value of the different pixel subunits at the same voltage.

In the embodiment, the third pixel subunits have different gap values such that the variation curve of the optical characteristic of the third pixel subunit versus the voltage at side view angles is equivalent to the mean value of the curve corresponding to the different gap values, and therefore, the brightness variation of the blue pixel subunit may be controlled for the mixed light at side view angles such that the complementary brightness saturation tendency of the third pixel subunit at side view angles is controlled to approximate to that of the first pixel subunit and the second pixel subunit. The brightness ratio of each of the red, green and blue pixel subunits can be maintained as the original ratio of the conventional technology by the complementary adjustment of the adjacent pixel units at a front view angle. That is, in the embodiments of the present application, the brightness of the red, green and blue pixel subunits exhibit approximate saturation tendency at a front view angle and at side view angles so as to improve color shift condition at side view angles.

It is not necessary to further subdivide the same pixel subunit and apply the different driving voltages to the subdivided pixel subunits respectively by the adjustment of the third pixel subunits in each of the pixel regions for the optical characteristics. Therefore, it is not need to design the additional metal or TFT components for driving the sub-pixels so as to save the backlight cost, and not need to sacrifice the transparent opening area so as to maintain the excellent transmittance of the panel.

In an embodiment, the third pixel subunit and the second pixel subunit are disposed adjacent to each other. For example, the thickness of the step structure gradually decreases along a direction away from the second pixel subunit. In this way, the gap value of the blue pixel subunit is smaller and the brightness of light emitted from the blue color pixel subunit is smaller at the position close to the second pixel subunit, the overall brightness of the third pixel subunit may be comprehensively adjusted and the overall brightness saturation tendency of the third pixel subunit at side view angles may be delayed such that it is approximate to that of the first pixel subunit and the second pixel subunit, thereby improving color shift condition at side view angles. The gap value of the blue pixel subunit is larger and the brightness of light emitted from the blue pixel subunit is larger at the position away from the second pixel subunit, and therefore, it is possible to compensate for the human eye that is less sensitive to the blue light.

In an embodiment, the first pixel subunit, the second pixel subunit and the third pixel subunit have the same contacting area with the substrate respectively and the first pixel subunit and the second pixel subunit are disposed adjacent to each other, and the second pixel subunit is located between the first pixel subunit and the third pixel subunit. As such, it is advantageous that the three primary colors of red, green and blue are mixed to obtain various colors.

In an embodiment, the photoresist film layer of the third pixel subunit has two-layered step structure. In this way, the two-layered step structure has two different thicknesses, for example, a step near the second pixel subunit has a first thickness, and a step away from the second pixel subunit has a second thickness. In a preferred embodiment, the first thickness is larger than the thickness of the photoresist film layer of the second pixel subunit, the second thickness is smaller than the thickness of the photoresist film layer of the second pixel subunit. At this time, the brightness of light emitted from the third pixel subunit having the two-layered step structure is more satisfied with the color shift requirement at side view angles.

In an embodiment, the photoresist film layer of the third pixel subunit has multi-layered step structure such that the variation curve of the overall brightness of the third pixel subunits versus the voltage at side view angles is more approximate to the target variation curve. For example, the photoresist film layer of the third pixel subunit has at least three-layered step structure. In this way, the more different gap values are between the photoresist film layer of the third pixel subunit and the second substrate, the optical characteristic curve of the third pixel subunit can be adjusted more finely such that the displaying effect of the display panel is better. As another example, the photoresist film layer of the third pixel subunit has four-layered step structure such that the four different gap values are between the photoresist film layer of the third pixel subunit and the second substrate and represented as B-Gap1, B-Gap2, B-Gap3 and B-Gap4 from small to large respectively, the amounts of the phase delay respectively corresponding thereto are represented as Δ nd_{B-Gap1}, Δ nd_{B-Gap2}, Δ nd_{B-Gap3} and Δ nd_{B-Gap4} respectively, there is a difference between B-Gap1, B-Gap2, B-Gap3 and B-Gap4 such that the actual amounts of the phase delay of the third pixel subunit in the same pixel region are equal to about a mean value of Δnd_{B-Gap1}, Δnd_{B-Gap2}, Δ nd_{B-Gap3} and Δnd_{B-Gap4}, and thus it can realize a complementary optical effect to compensate an affect caused by chromatic aberration at different view angles.

As an embodiment, as shown in FIG. 5, the thickness of the at least three-layered step structure uniformity decreases along a direction away from the second pixel subunit so as to simplify the process for the photoresist film layer of the third pixel subunit. As another embodiment, as shown in FIG. 5b, the thickness of the at least three-layered step structure gradually decreases at a curve along a direction away from the second pixel subunit and thus the increasing tendency of the brightness of the blue pixel subunit along a direction away from the green pixel subunit is gentle generally, such that the mixed light of the blue light emitted from the blue pixel subunit, the red light emitted from the red pixel subunit and the green light emitted from the green pixel subunit is more uniform so as to improve the overall mixing effect of the display panel.

For example, the array substrate provided in the present application may be applicable to a liquid crystal display panel, an organic light-emitting diode (OLED) display panel, a quantum dot light-emitting diode display panel, a curved-surface display panel or a flexibility display panel, etc. Further, for example, the liquid crystal display panel may be a twisted nematic (TN-) type liquid crystal display panel, an optically complementary birefringence (OCB) type liquid crystal display panel and a vertical alignment (VA) type liquid crystal display panel, etc.

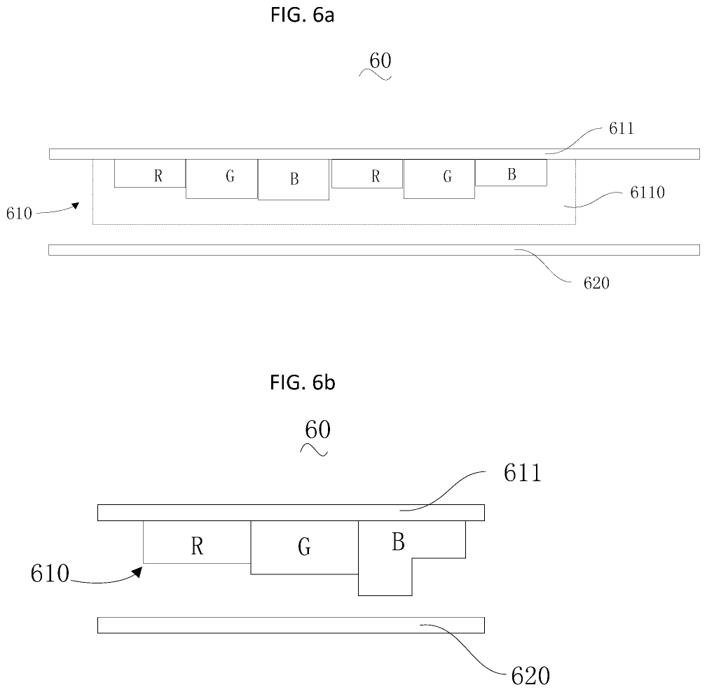

The present application further discloses a display panel, please refer to FIG. 6a and FIG. 6b together, the display panel 60 includes a first substrate 610 and a second substrate 620 which are disposed to oppose each other, wherein the first substrate 610 includes a substrate 611 on which a plurality of pixel units are disposed, each of the pixel units include a first pixel subunit, a second pixel subunit and a third pixel subunit, for example, each of the pixel units include a red pixel subunit, a green pixel subunit and a blue pixel subunit. The photoresist film layer is disposed on the each of the pixel subunits, and the photoresist film layers of the different pixel subunits in the same pixel unit are made of different materials such that the different pixel subunits in the same pixel unit emit light having the different colors. For example, a red photoresist film layer R is disposed on the red pixel subunit, a green photoresist film layer G is disposed on the green pixel subunit, and a blue photoresist film layer B is disposed on the blue pixel subunit.

As an embodiment, as shown in FIG. 6a, the plurality of pixel regions 6110 are disposed on the substrate 611, each of the pixel regions includes a plurality of pixel units, specifically, the blue photoresist film layers of the two adjacent blue pixel subunits in each of the pixel regions 6110 have different thicknesses.

As another embodiment, as shown in FIG. 6b, the photoresist film layer of the third pixel subunit has a step structure that is the blue photoresist film layer B has the step structure; for example, the photoresist film layer of the third pixel subunit has a multi-layered step structure, the step structures on the same layer have the same thickness; further, for example, for the step structures of the two adjacent layers, the thickness of the step structure on the lower layer is larger than that on the upper layer.

For example, the structure of the first substrate is as same as that of the array substrate described in any one of the aforementioned embodiments. Optionally, a TFT array is also disposed on the first substrate 610 or on the second substrate 620. Wherein, the TFT array is optionally a TFT array having a bottom gate structure or a top gate structure.

In an embodiment, the liquid crystal material is filled between the first substrate 610 and the second substrate 620 to form a liquid crystal display panel.

According to the present application, the structures of the blue pixel subunits are adjusted for the optical characteristic of the blue pixel subunits, when the blue photoresist film layers in the same pixel region are adjusted to have different thicknesses, the short wavelength and high color shift conditions are compensated so as to realize a complementary optical effect, thereby solving the chromatic aberration and color shift problems of the display panel. The aforementioned processes for the array substrate are simple and can improve the display performance of the display device.

The array substrate provided in the present application may be a liquid crystal display panel, an OLED display panel, a Q LED display panel, a curved-surface display panel or a flexible display panel, etc. Further, for example, the liquid crystal display panel may be a twisted nematic (TN-) type liquid crystal display panel, an optical compensated birefringence (OCB) type liquid crystal display panel and a vertical alignment (VA) type liquid crystal display panel, etc.

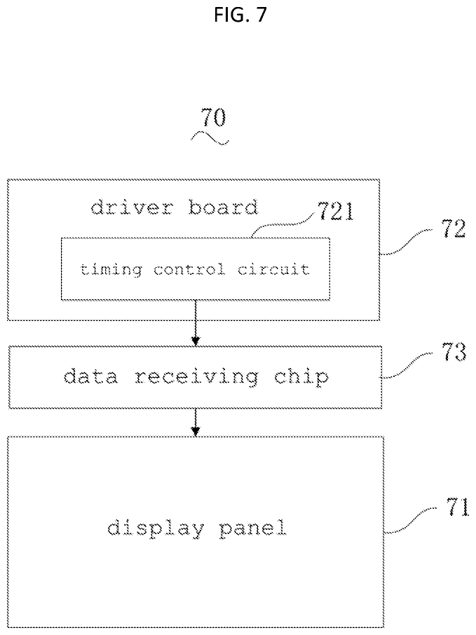

Please refer to FIG. 7, which is a schematic structural diagram of a display device of an embodiment. The display device 70 includes a display panel 71, a driver board 72 and a data receiving chip 73, the data receiving chip 73 and the display panel 71 are connected to each other, the display panel 71 includes the array substrate described in any one of the above embodiments. For example, the display panel 71 is the display panel shown in FIG. 6a or FIG. 6b; further, for example, the display panel 71 includes a first substrate and a second substrate which are disposed to oppose each other, the first substrate includes a plurality of pixel regions are disposed on a substrate, wherein each of the pixel regions includes a plurality of pixel units individually including a red pixel subunit, a green pixel subunit and a blue pixel subunit; and a plurality of blue photoresist film layers individually disposed on each of the pixel subunits, for example, a red photoresist film layer is disposed on the red pixel subunit, a green photoresist film layer is disposed on the green pixel subunit, a blue photoresist film layer is disposed on the blue pixel subunit.

Optionally, the photoresist film layer of the third pixel subunit of each of the pixel units has a step structure. Alternatively, the blue photoresist film layers of the two adjacent blue pixel subunits have different thicknesses in each of the pixel regions.

Further, for example, a TFT array is also disposed on the first substrate or on the second substrate, wherein the TFT array may be selected as a TFT array having a bottom gate structure or a top gate structure.

In an embodiment of the present application, the driver board 72 includes a timing control circuitry 721, the timing control circuitry 721 and the data receiving chip 73 are connected to each other, the timing control circuitry 721 is configured to process the initial driving voltage signal for each of the pixel subunits when the blue photoresist film layers of the two adjacent blue pixel subunits have different thicknesses in each of the pixel regions, such that the driving voltages of the plurality of blue pixel subunit in the same pixel region are same, and the timing control circuitry 721 is configured to output the processed driving voltage signal to the data receiving chip 73.

In an embodiment, the timing control circuitry 721 is configured to process the initial driving voltage signals for each of the pixel subunits, such that the processed driving voltage of the plurality of blue pixel subunits at the same column/row in the same pixel region is equal to the mean value of the initial driving voltages of the blue pixel subunits in the pixel region, and timing control circuitry 721 is configured to output the processed driving voltage signal to the data receiving chip 73.

In an embodiment, the timing control circuitry 721 is further configured to output the processed driving voltage signal to the data receiving chip 73 at the displaying time of the next frame after processing the initial driving voltage signal for each of the pixel subunits.

For example, the timing control circuitry 721 includes a signal processing unit and a storage unit, the signal processing circuit is configured to process the initial driving voltage signal for each of the pixel subunits such that the processed driving voltages of the plurality of blue pixel subunits at the same column/row in the same pixel region are same; the storage unit is connected to the signal processing unit, and configured to receive and store the processed driving voltage signal and output the processed driving voltage signal at the displaying time of the next frame.

In an embodiment of the present application, the timing control circuitry 721 receives an image data signal and processes the received image data signal to convert the type of the image data signal into other type of the image data signal supported by the data receiving chip 73, and the timing control circuitry 721 outputs the processed image data signal to the data receiving chip 73 of the display panel. The processed image data signal not only includes the driving voltage signal of each of the pixel subunits, but further includes a scanning signal.

In the embodiments of the present application, the structures of the blue pixel subunits are adjusted for the optical characteristic of the blue pixel subunits, when the blue photoresist film layers in the same pixel region are adjusted to have different thicknesses, the short wavelength and high color shift conditions are compensated so as to realize a complementary optical effect, thereby solving the chromatic aberration and color shift problems of the display panel.

In the embodiments of the present application, the display device may be a liquid crystal display device, an OLED display device or a QLED display device, a curved-surface display device, a flexible display device, etc. Further, for example, the liquid crystal display device may be a twisted nematic (TN-) type liquid crystal display panel, an optical compensated birefringence (OCB) type liquid crystal display panel and a vertical alignment (VA) type liquid crystal display panel, etc.

The technical features of the above embodiments can be arbitrarily combined, to make the concise description, the all possible combinations of the technical features in the aforementioned embodiments are not all described. However, these technical features should be covered by the appended claims as long as the combinations of these technical features do not contradict each other. The only some specific implementations of the present application are described in detail in the above embodiments, it should not be interpreted in any way that limits the scope of the present application. It should be note that any equivalent modification or change can be made to the technical features described herein without departing from the scope and the spirit of the present application and is covered by the appended claims. Therefore, the protection scope of the present application should be subjected to the scope defined by the appended claims.

What is claimed is:

1. An array substrate, comprising:
a plurality of pixel regions are disposed on a substrate, wherein each of the pixel regions includes a plurality of pixel units individually including a red pixel subunit, a green pixel subunit and a blue pixel subunit; and
a plurality of blue photoresist film layers individually disposed on each of the blue pixel subunits;
wherein the blue photoresist film layers of the two adjacent blue pixel subunits in each of the pixel regions have different thicknesses.

2. The array substrate of claim 1, wherein each of the pixel regions comprises:
the plurality of pixel units arranged in an array.

3. The array substrate of claim 2, wherein:
the pixel unit in each pixel area has the same number of columns as rows; and
the thickness of the blue photoresist film layer at column i and row j is as same as the thickness of the blue photoresist film layer at column j and row i;
wherein i and j are all smaller than or equal to the number of columns.

4. The array substrate of claim 3, wherein each of the pixel regions comprises:
four pixel units arranged in two columns and two rows;
wherein the blue photoresist film layers of the blue pixel subunits in the two pixel units that are arranged diagonally have same thickness.

5. The array substrate of claim 1, wherein:
the green pixel subunit is located in the middle of the red pixel subunit and the blue pixel subunit in each of the pixel units.

6. A display panel, comprising:
a first substrate; and
a second substrate;
wherein the first substrate and the second substrate are disposed to oppose each other;
the first substrate comprises:
a plurality of pixel regions are disposed on a substrate, wherein each of the pixel regions includes a plurality of pixel units individually including a red pixel subunit, a green pixel subunit and a blue pixel subunit; and
a plurality of blue photoresist film layers individually disposed on each of the blue pixel subunits;
wherein the blue photoresist film layers of the two adjacent blue pixel subunits in each of the pixel regions have different thicknesses.

7. The display panel of claim 6, wherein each of the pixel regions comprises:
the plurality of pixel units arranged in an array.

8. The display panel of claim 7, wherein:
the pixel unit in each pixel area has the same number of columns as rows; and
the thickness of the blue photoresist film layer at column i and row j is as same as the thickness of the blue photoresist film layer at column j and row i;
wherein i and j are all smaller than or equal to the number of columns.

9. The array substrate of claim 8, wherein each of the pixel regions comprises:
four pixel units arranged in two columns and two rows;
wherein the blue photoresist film layers of the blue pixel subunits in the two pixel units that are arranged diagonally have same thickness.

10. The array substrate of claim 6, wherein:
the green pixel subunit is located in the middle of the red pixel subunit and the blue pixel subunit in each of the pixel units.

11. A display device, comprising:
a data receiving chip;
a display panel; and
a driver board including a timing control circuit;
wherein the data receiving chip and the display panel are connected to each other;
the timing control circuit and the data receiving chip are connected to each other, the timing control circuit is configured to process an initial drive voltage signal for each of the pixel subunits, such that the processed driving voltages of the plurality of blue pixel subunits at the same column/row in the same pixel region are same, and configured to output the processed driving voltage signal to the data receiving chip;
the display panel comprises:
a first substrate; and
a second substrate disposed to oppose the first substrate;
wherein the first substrate comprises:
a plurality of pixel regions are disposed on a substrate, wherein each of the pixel regions includes a plurality of pixel units individually including a red pixel subunit, a green pixel subunit and a blue pixel subunit; and
a plurality of blue photoresist film layers individually disposed on each of the blue pixel subunits;
wherein the blue photoresist film layers of the two adjacent blue pixel subunits in each of the pixel regions have different thicknesses.

12. The display device of claim 11, wherein the timing control circuit is configured to process the initial drive voltage signal for each of the pixel subunits, such that the processed driving voltage of each of the plurality of blue pixel subunits is equal to a mean value of the initial driving voltages of the plurality of blue pixel subunits at the same row/column in the same pixel region, and the timing control circuit is configured to output the processed driving voltage signal to the data receiving chip.

13. The display device of claim 12, wherein the timing control circuit is further configured to output the processed driving voltage signal to the data receiving chip at a displaying time of the next frame after processing the initial drive voltage signal for each of the pixel subunits.

14. The display device of claim 13, wherein the timing control circuit comprises:
a signal processing unit configured to process the initial drive voltage signal for each of the pixel subunits, such that the processed driving voltages of the plurality of blue pixel subunits at the same column/row in the same pixel region are same; and
a storage unit configured to receive and store the processed driving voltage signal, and output the processed driving voltage signal at a displaying time of the next frame.

15. The display device of claim 11, wherein each of the pixel regions comprises:
the plurality of pixel units arranged in an array.

16. The display device of claim 15, wherein:
the pixel unit in each pixel area has the same number of columns as rows; and
the thickness of the blue photoresist film layer at column i and row j is as same as the thickness of the blue photoresist film layer at column j and row i;
wherein i and j are all smaller than or equal to the number of columns.

17. The array substrate of claim 16, wherein each of the pixel region comprises:
four pixel units arranged in two columns and two rows;
wherein the blue photoresist film layers of the blue pixel subunits in the two pixel units that are arranged diagonally have same thickness.

18. The array substrate of claim 11, wherein:
the green pixel subunit is located in the middle of the red pixel subunit and the blue pixel subunit in each of the pixel units.
